(19) United States
(12) Patent Application Publication
(10) Pub. No.: US 2010/0211874 A1
(43) Pub. Date: Aug. 19, 2010

(54) Emulating a USB drive to provide media files to a media player

(76) Inventor: Yoav Weiss, Petach Tikva (IL)

Correspondence Address: G. F. Gallinger, 7420 Milner Dr., Colorado Springs, CO, 80920, US

(21) Appl. No.: 12/658,999

(22) Filed: Feb. 18, 2010

Related U.S. Application Data
(60) Provisional application No. 61/208,039, filed on Feb. 19, 2009.

(51) Int. Cl. G06F 15/16; G06F 3/01; G06F 13/12

(52) U.S. Cl. 715/716; 709/231; 710/74

(57) ABSTRACT

A method of streaming a media file stored on a networked computer, to a media player having a USB port to input data thereto, comprising the following steps: i) providing a media retrieval device having: a) a USB jack to receive power and transmit data received to the media player, b) connection to a computer network through a router for reception of data from the networked computer, and wherein, c) said media retrieval device is capable of being programmed, of emulating a USB drive, and then subsequently redirecting a selection to a remote source file; ii) connecting the USB jack of the media retrieval device to the USB port of the player; iii) selecting a media file from the network computer; and, iv) playing the selected media file on the media player. Media files, from which the selection is made from, are conveniently always current with the media files on the networked computer. In a preferred aspect of this invention the network computer is connected to a wireless router and wherein the media retrieval device has USB powered wireless radio hardware for wireless connection to the router.

### PRIOR APPLICATION

The priority of U.S. Provisional Application No. 61/208,039, with the above title, filed by Yoav Weiss on Feb. 19, 2009 is claimed.

### FIELD OF THE INVENTION

This invention relates to wireless transmission and/or streaming of media files to media players. More particularly this invention relates to a method wherein a media retrieval device emulates a USB drive when plugged into the USB port on the media player. The media retrieval device may be programmed to initially present directories and titles of media selections, available from a local drive, locally networked computers, as well as web servers. The media retrieval device may be programmed with internal download restrictions to prevent “ripping” web based files to a computer.

### BACKGROUND OF THE INVENTION

Many media players are provided with a USB port. Within this specification a media player is defined and intended to include not only a DVD or Blu-Ray media player, but additionally a television, a home theater system, a video game console, a personal computer, a stereo, or a digital picture frame. Generally the USB port has been provided to allow the media player to play a file on a USB drive plugged into the USB port. When a USB device is connected through that port, the media player assumes it is a disk with a file system that is compatible with Windows, a TM of Microsoft Corporation. When a selection is made, the compatible media file is then loaded so that is available for viewing or listening. Most all media players have minimal storage capabilities. Generally media players can only play files stored on a disc, or cached in a flash drive.

Through the internet, computers have access to almost every available title of song and videos. When individuals purchase music albums and videos, they generally download and store media files on their computer hard drives so that they can subsequently transmit, access, and re-access them. Presently there is no convenient means of linking the relatively vast libraries which individuals keep on their computers with the audio/video players that they use. In order to play a selection on a portable player, the selection must be first downloaded and stored onto a disk or flash drive. Then, only after the download is completed, and after the storage device has been moved to the player, is the user able to play the download on the player. The presence of space consuming, dust collecting boxes, and titles stored in varying media formats is common. What is needed is a device which can facilitate access to, and subsequent download, and concurrent playing of titles directly from storage locations anywhere on a network. What also is needed is a method of using a USB retrieval device which includes an initial display of a menu of media files which are available for selection.

Within this specification a networked computer is defined to include any computer or media server connected to the world wide web, including a local computer which may or may not have web access, said local computer being connected to a router, and said router being connected to a media player. Within this specification a router is defined and intended to include a switch not having a firewall. Within this specification streaming is intended to include downloading or copying a file, as well as streaming a file which generally does not produce a copy of the file.

### OBJECTS OF THE INVENTION

It is an object of this invention to disclose a convenient method of loading and transmitting media files to a media player. It is an object of this invention to disclose a method of using a USB ported, media retrieval device. The method includes display of a menu comprising a root directory of media directories and media files which are available for selection. The media files displayed should potentially include listings available in folders and files stored: i) for static display of setup instructions; ii) from a drive connected to the media player; iii) from a selected computer within a local network; iv) from internet listings such as youtube.com, jellytelly.com or disney.com; or v) through a locally networked computer screen, after either VNC or RDP, programs which remotely display a computer screen, are selectively loaded so that a laptop or other means of making selections can be utilized. After a selection is made, the selection is redirected so that data in the selected source folder is subsequently wirelessly streamed to the media player. When a selected media file is streamed in real time as it is concurrently played, the present practice of downloading each title and file onto a secondary storage medium (not shown) prior to use, and subsequently locating, and moving that storage medium to the media player can be entirely eliminated. It is an object of this invention to eliminate the presence of a space consuming, dust collecting boxes, of both audio and video titles in varying media formats. It is yet a further object of this invention to save time and expense. It is a final object of this invention to disclose a more efficient and convenient method of organizing an enormity of audio and video mediums.

One aspect of this invention provides for a method of streaming a media file stored on a networked computer, to a media player having a USB port to input data thereto, comprising the following steps: i) providing a media retrieval device having: a) a USB jack to receive power and transmit data received to the media player, b) connection to a computer network through a router for reception of data from the networked computer, and wherein, c) said media retrieval device is capable of being programmed, of emulating a USB drive, and then subsequently redirecting a selection to a remote source file; ii) connecting the USB jack of the media retrieval device to the USB port of the player; iii) selecting a media file from the network computer; and, iv) playing the selected media file on the media player. Media files from which the selection is made from are conveniently always current with the media files on the networked computer.

In a preferred aspect of this invention the network computer is connected to a wireless router and wherein the media retrieval device has USB powered wireless radio hardware for wireless connection to the router.

Various other objects, advantages and features of this invention will become apparent to those skilled in the art from the following description in conjunction with the accompanying drawings.

### FIGURES OF THE INVENTION

FIG. 1 is a schematic perspective view of a wireless media streaming device connected by a USB jack to a media player. FIG. 1 additionally depicts a computer network connecting both locally networked computers as well as media servers on the world wide web.

FIG. 2 is an illustration showing a Menu of Available Media Files or a Root Directory which might be displayed by the media retrieval device.

FIG. 3 is a Partial Directory Tree corresponding to selection of the folder disney.com shown in the root directory shown in FIG. 2.

FIG. 4 is a flow diagram depicting a suggested operational algorithm for the media retrieval device.

FIG. 5 is a flow diagram showing a possible file delivery authorization algorithm which might replace box “Display File” shown in FIG. 4 above.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

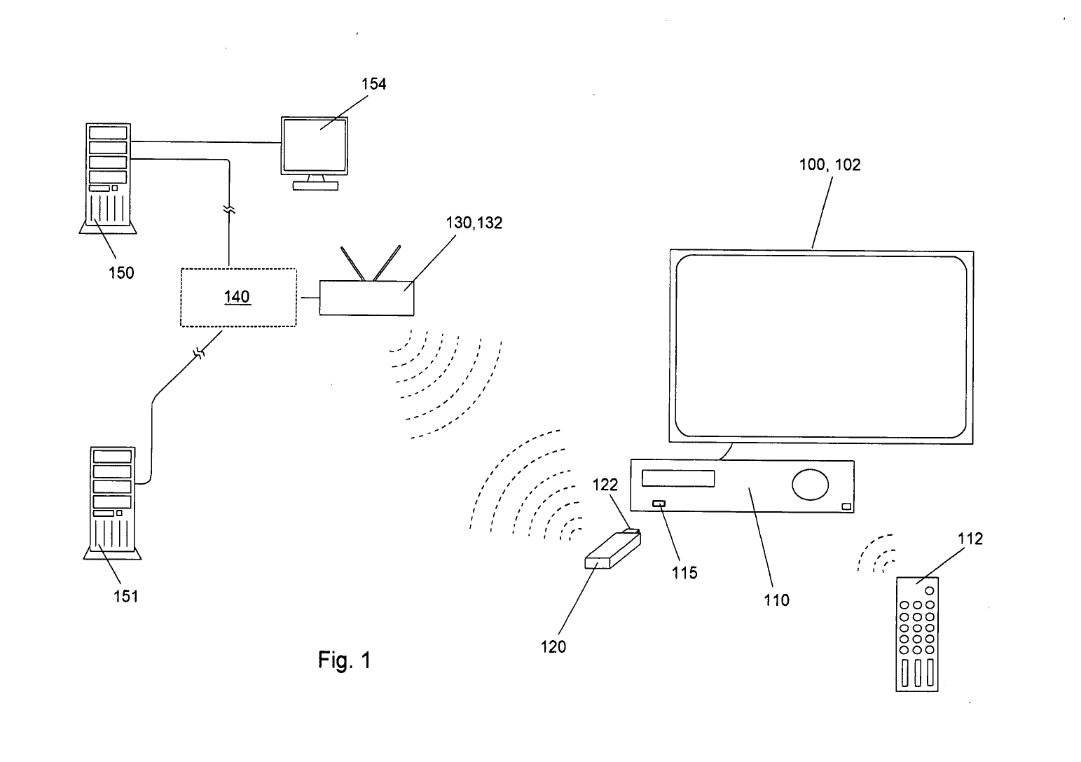

Turning now to the drawings and more particularly to FIG. 1 we have a schematic perspective view of a wireless media streaming device 120 connected by a USB jack 122 to a media player 110. The media player is connected to a display monitor 100, which might comprise a television 102. FIG. 1 additionally depicts a computer network 140 connecting both locally networked computers 150 as well as media servers 151 connected to the world wide web. Most generally, a method of streaming a media file 340 stored on a networked computer 150, 151 to a media player 110 having a USB port 115 to input data thereto, comprises the following steps: i) providing a media retrieval device 120 having: a) a USB jack 122 to receive power and transmit data received to the media player 110, b) connection to a computer network 140 through a router 130 for reception of data from the networked computer 150,151 and wherein, c) said media retrieval device 120 is capable of being programmed, of emulating a USB drive, and then subsequently redirecting a selection to a remote source file 340; ii) connecting the USB jack 115 of the media retrieval device 120 to the USB port 122 of the player 110; iii) selecting a media file 340 from the networked computer 150,151; and, iv) playing the selected media file 340 on the media player 110. Media files 340, from which the selection is made from, are conveniently always current with the media files 340 on the networked computer 150,151.

In a preferred aspect of this invention the network computer 150,151 is connected to a wireless router 132 and wherein the media retrieval device 120 has USB powered wireless radio hardware for wireless connection to the wireless router 132.

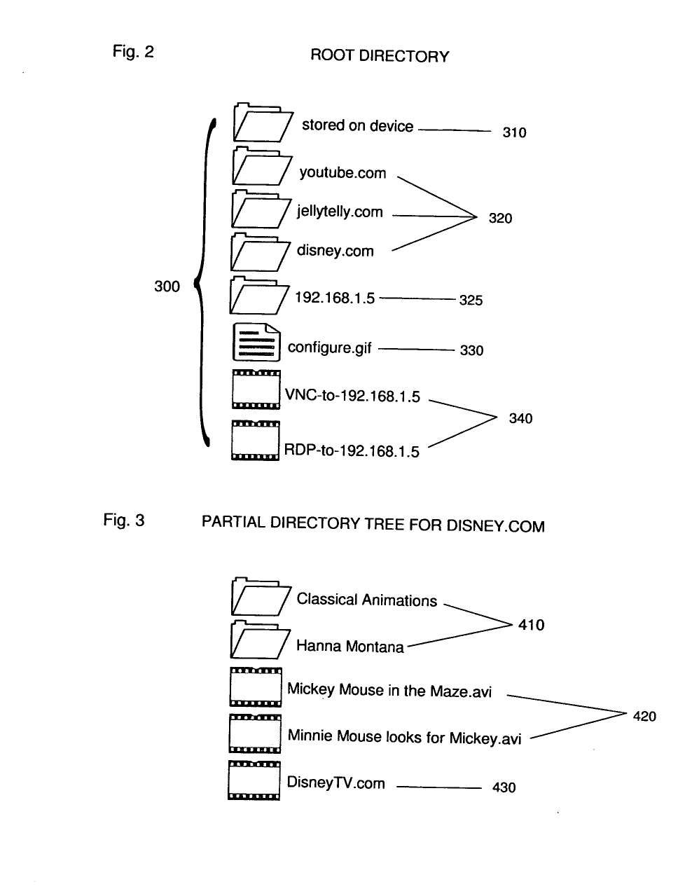

FIG. 2 is an illustration showing a Menu of Available Media Files or a Root Directory which might be displayed by the media retrieval device. Most preferably, a menu or directory of available media files 300 is presented on the media player 110. The root directory of the media files 300 can be first viewed on the display monitor 100 of the media player 110, prior to making a selection therefrom, and viewing. The menu or directory of available media files 300 further comprises folders 310,320,325 and of media files 330,340, and wherein media folders 310,320,325 can be selected and subsequently viewed. The menu of available media files 300 allows selection of folders 325 on a locally networked computer 150 as well as media folders 310,320 available through the network. It is contemplated that a remote access program is automatically loaded to display a monitor 154 of a locally networked computer 150. It is likely that either a remote desktop, such as RDP, or VNC, a TM of RealVDN Ltd. would be loaded to remotely display the monitor 154 shown on the locally networked computer 150, so that said computer 150 could be remotely manipulated to access the web.

In the most preferred embodiment of the invention the menu of available media files 300 further comprises media files 310 read directly by the media retrieval device 120 as well as a static image file 330 showing setup directions for the media retrieval device 120. For example, this would include the URL web address of the media retrieval device 120 which must be entered on a computer's browser when the media retrieval device 120 is directly connected to the network. When the media player 110 further comprises a remote control 112, the remote control 112 of the media player 112 can be used to highlight, and subsequently select a media folder 310 available directly to the media player 110, a media folder 320 available through the internet, a media folder locally available through networked computer 325, or media files 340 available through the network. A selection from the menu of available media files 300 can be completely and remotely accomplished with the media remote controller 112 while viewing the media player 110.

FIG. 3 is a Partial Directory Tree corresponding to selection of the folder disney.com 320 shown in the root directory shown in FIG. 2. This level of the directory tree, folders 410 are available for selection. Alternatively, any one of the video files 420,430 may be selected.

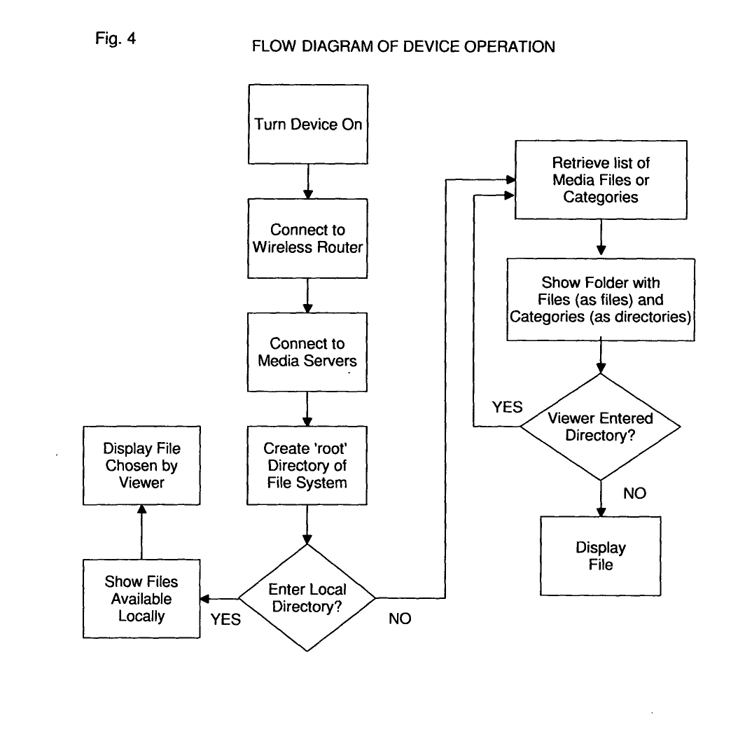

FIG. 4 is a schematic flow diagram depicting a suggested operational algorithm for the media retrieval device. The flow diagram shown in FIG. 4 does not contemplate the media retrieval device having built in protections against a user making an unauthorized copy of a video sold only for viewing. Providers of videos are all contemplated to have much interest in utilizing the technology disclosed in this specification to facilitate convenient streaming and display of their intellectual property. Such interest would be subject to built in safeguards preventing unauthorized ripping or copying of the streamed media files 340. The assignees of this invention, Home Server Technologies Inc., having website HSTi.com, are presently engaged in licensing discussions with some thirty companies including media distribution companies.

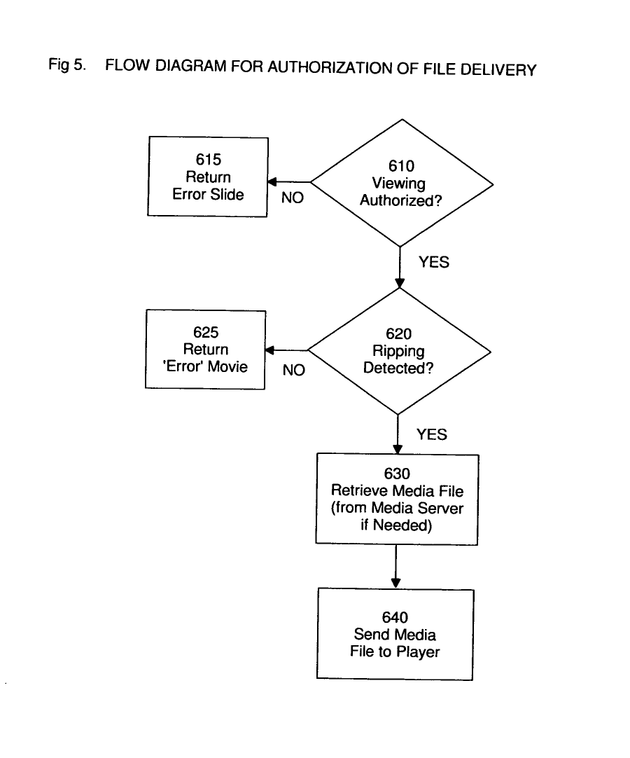

FIG. 5 is a flow diagram showing a possible file delivery authorization algorithm which might replace the box entitled, “Display File” shown in FIG. 4. The flow diagram shown in FIG. 5 contemplates the use of safeguards built into the media retrieval device which would prevent unauthorized viewing, as well as “ripping” of video files for subsequent sale or unauthorized use. Without such built in safeguards industry wide use of the media retrieval device and the methodology disclosed in this specification would be narrowly circumscribed.

Potentially wanted safeguards might include simply the number of times the file could be played, or the time of day a restricted movie might be played, to prevent viewing by children normally asleep during late night. If the viewing is found not to be authorized 610, the device 120 could return a static error slide 615 which explains why the viewing is not authorized, and what to do to authorize it, i.e. paying an additional sum for a longer rental. If the device is authorized in step 610, then the device must nexzt determine whether if there is an attempt to “rip” the file 620 (by copying the media file 340 to a computer). If so, in step 625 it returns an “error” movie, one that does not contain the actual media. For example, the error movie might include the first 10 minutes of the movie, followed by a static image telling the viewer how to pay for a legal copy. If there is no determined intent to “rip” the file then the media file is retrieved 630 and sent to the media player 640.

There are multiple methods to detect ripping in step 620. Here are a few examples:

1. Have the file system contain trap files, files that are not media files. Media players ignore such files. However, if the device is plugged into a general purpose PC, those files will be opened to create thumbnails for them. An attempt to open such files proves that the device 120 is not connected to a media player 110, and therefore this is an attempt to rip a file illegally.

2. Have the device present “trap” functions. A media player will only attempt to open a USB device as a storage device. A general purpose PC will attempt to use it as any device it can use, such as a keyboard or mouse, Therefore if any attempt to use the device as anything other than a storage device is detected, this is an attempt to rip a file illegally.

3. Have the device offer a virtual CD-ROM device with an autorun file. PCs run autorun files, media players do not.

4. Present additional partitions with trap file systems. Media players usually only support the FAT file system. If the device attempts to mount a file system that it reports has a different type, the device is a PC.

5. For media file types that have an index, make the player seek to arbitrary locations. A media player playing the file will seek to those arbitrary locations. A PC copying the file will not.

6. Detect the read speed. Media players have limited memory, and read media files in real time (plus a buffer), A PC copying a file would usually attempt to read a lot faster.

7. Detect if not all media files are not opened shortly after the directory is opened. Normally a media player would open all media the files available to it to create icons for them.

While the invention has been described with preferred specific embodiments thereof, it will be understood that this description is intended to illustrate and not to limit the scope of the invention, which is defined by the following claims.

I claim:

1) A method of streaming a media file stored on a networked computer, to a media player having a USB port to input data thereto, comprising the following steps:
i) providing a media retrieval device having: a) a USB jack to receive power and transmit data received to the media player, b) connection to a computer network through a router for reception of data from the networked computer, and wherein, c) said media retrieval device is capable of being programmed, of emulating a USB drive, and then subsequently redirecting a selection to a remote source file;
ii) connecting the USB jack of the media retrieval device to the USB port of the player;
iii) selecting a media file from the network computer; and,
iv) playing the selected media file on the media player;
so that the media files from which the selection is made from are conveniently always current with the media files on the networked computer.

2) A method as in claim 1 wherein the network computer is connected to a wireless router and wherein the media retrieval device has USB powered wireless radio hardware for wireless connection to the wireless router.

3) A method as in claim 1 further comprising a menu or root directory of available media files presented on the media player, and wherein the menu or root directory of the media files is viewed on the display monitor of the media player, prior to making a selection therefrom, and viewing.

4) A method as in claim 3 wherein the menu of available media files further comprises folders of media files, and wherein files within media folders can be selected and subsequently viewed.

5) A method as in claim 4 wherein the menu of available media files allows selection of folders on a locally networked computer as well as media folders available through the internet.

6) A method as in claim 5 wherein a remote access program is loaded to display a monitor of a locally networked computer.

7) A method as in claim 5 wherein the menu of available media files further comprises media files available on a drive in the media retrieval device as well as a static screen showing setup directions for the media retrieval device such as the URL web address of the media retrieval device which must be entered on a computer's browser when the media retrieval device is directly connected to the network.

8) A method as in claim 7 wherein the media player further comprises a remote control, and wherein remote control of the media player can be used to highlight, and subsequently select a media file, a media folder, a locally networked computer, or media files available through the internet, so that a selection from the menu can be completely and remotely made with the media remote controller while viewing the media player.

9) A method as in claim 1 wherein further comprising inclusion of steps containing checks against unauthorized viewing or “ripping” of a streamed media file for subsequent sale or use.
